(19) United States
(12) Patent Application Publication
(10) Pub. No.: US 2009/0022588 A1
(43) Pub. Date: Jan. 22, 2009

(54) Electric fan module and airflow conduction structure thereof

(75) Inventor: Michael Chen, Taipei Hsien (TW)

Correspondence Address: Joe McKinney Muncy, PO Box 1364, Fairfax, VA, 22038-1364, US

(73) Assignee: TOPOWER COMPUTER INDUSTRIAL CO., LTD.

(21) Appl. No.: 11/826,485

(22) Filed: Jul. 16, 2007

(51) Int. Cl. F03B 3/12

(52) U.S. Cl. 415/218.1

(57) ABSTRACT

The present invention discloses an electric fan module and an airflow conduction structure thereof, wherein the airflow conduction structure is coupled to an electric fan and guides the central airflow to fan blades to reduce wind resistance and wind shear. The airflow conduction structure has an airflow conduction body and at least one airflow conduction groove arranged axially on the airflow conduction body. The airflow conduction body has a first end face and a second end face, and the first end face is greater than the second end face. The airflow conduction grooves are arranged between the first and second end faces.

### FIELD OF THE INVENTION

The present invention relates to an electric fan module and an airflow conduction structure thereof, particularly to an electric fan module and an airflow conduction structure thereof, wherein the heat dissipation efficiency is promoted via guiding the central airflow to the fan blades.

### BACKGROUND OF THE INVENTION

There are everywhere electronic devices in our living and working environments. An electronic device is formed of many electronic elements, which generate heat during operation. Heat may induce low efficiency or even operational interruption. Therefore, a heat-dissipation device is usually arranged above or near a heat-generating electronic element to fast take away heat and decrease the temperature of the electronic element so that the electronic element can operate normally. The manufacturers usually increase the heat-dissipation efficiency of an electric fan via modifying the structures of the electric fan casing or fan blades or via increasing the rotation speed of the electric fan, which are expected to increase the incoming airflow and outgoing airflow.

A R.O.C. patent No. M300958 disclosed an “Axial Flow Heat Dissipation Electric Fan”, which comprises: a casing and a fan core. The casing has an upper airflow inlet, a lower airflow outlet, an airflow conduction structure and a central magnetic induction stator. The airflow conduction structure has a plurality of non-contact vanes uniformly and annularly arranged along the perimeter of the airflow conduction structure. The fan core has a rotation shaft pivotally installed in a bearing at the center of the casing. The fan core also has a hub, and a plurality of fan blades is uniformly arranged around the hub. A magnetic induction rotator is arranged inside the hub, and the rotation shaft is also installed inside the hub. In the conventional technology, a plurality of vanes is arranged in the external rim of the casing to provide lateral airflow and enhance the heat dissipation effect. However, the axial portion of the electric fan is a plane, which is apt to create wind resistance or a vacuum state and results in a poor heat dissipation effect.

A R.O.C. patent publication No. 478560 disclosed an “Improved Fan Blade Structure”, which comprises: an axial portion and a plurality of fan blades. The axial portion has a dome-shape surface at the front thereof and has a central hole for installing a shaft. The fan blades are annularly and obliquely arranged along the perimeter of the axial portion. The dome-shape surface has a circular plane at the top thereof. The fan blades extend from the perimeter of the axial portion toward the top of the axial portion. The front edges of the fan blades are at the same altitude of the top circular plane of the axial portion. The conventional technology extends the fan blades to increase the area of the fan blades without increasing the thickness of the fan blades, which is expected to achieve full ventilation and higher heat-dissipation efficiency. However, due to the extended fan blades, the axial portion has an uneven surface, which is apt to create wind resistance and wind shear and result in a poor heat dissipation effect.

### SUMMARY OF THE INVENTION

The primary objective is to guide the central airflow to fan blades to overcome the conventional problem that a vacuum state or wind shear is created at the central region during the rotation of an electric fan and to reduce wind resistance and promote heat dissipation efficiency.

To achieve the abovementioned objective, the present invention proposes an electric fan module and an airflow conduction structure thereof. The airflow conduction structure is coupled to an electric fan and comprises: an airflow conduction body and at least one airflow conduction groove axially arranged on the airflow conduction body. The airflow conduction body has a first end face and a second end face, and the first end face is greater than the second end face. The airflow conduction grooves are arranged between the first end face and the second end face.

### BRIEF DESCRIPTION OF THE DRAWINGS

FIG. 1 is a perspective view schematically showing the appearance of the electric fan module and the airflow conduction structure according to the present invention.

FIG. 2 is an exploded view schematically showing the structure of the electric fan module and the airflow conduction structure according to the present invention.

FIG. 3A and FIG. 3B are diagrams schematically showing the embodiments of the present invention.

FIG. 4 is a sectional view schematically showing the airflow flowing in the electric fan module and the airflow conduction structure according to the present invention.

### DETAILED DESCRIPTION OF THE PREFERRED EMBODIMENTS

Below, the technical contents of the present invention are to be described in detail in cooperation with the drawings.

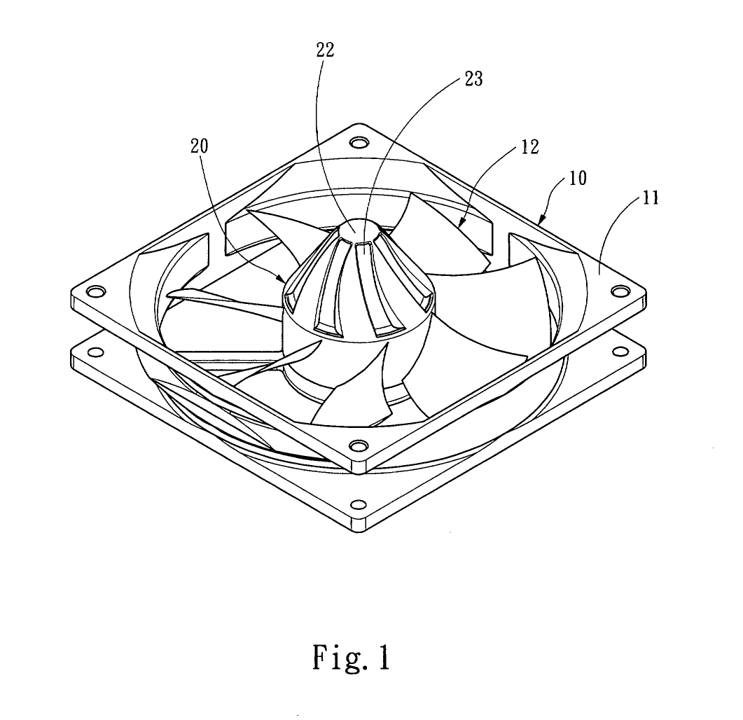

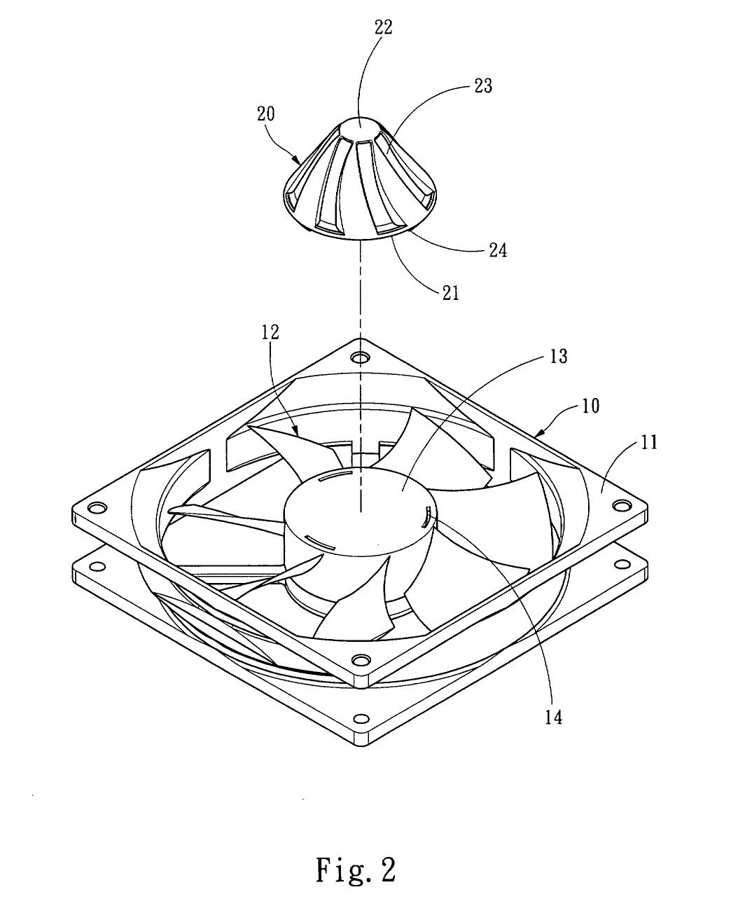

Refer to FIG. 1 and FIG. 2 a perspective view and an exploded view respectively schematically showing the appearance and structure according to the present invention. The present invention includes an electric fan 10. The electric fan 10 has a casing 11 and a fan blade assembly 12. The fan blade assembly 12 is coupled to an airflow conduction body 20. The airflow conduction body 20 has a first end face 21 and a second end face 22, and the first end face 21 is greater than the second end face 22. The fan blade assembly 12 has a central portion 13 corresponding to the first end face 21, and the area of the central portion 13 is identical to the area of the first end face 21. The airflow conduction body 20 has at least one airflow conduction groove 23 axially arranged between the first and second end faces 21 and 22. In the embodiments shown in the drawings, the airflow conduction body 20 is a truncated cone, and the airflow conduction grooves 23 are radiately arranged on the airflow conduction body 20 and corresponding to the airflow direction. The electric fan 10 may be an axial flow fan or a centrifugal fan. According to the architecture described above, the electric fan module and airflow conduction structure of the present invention is thus established.

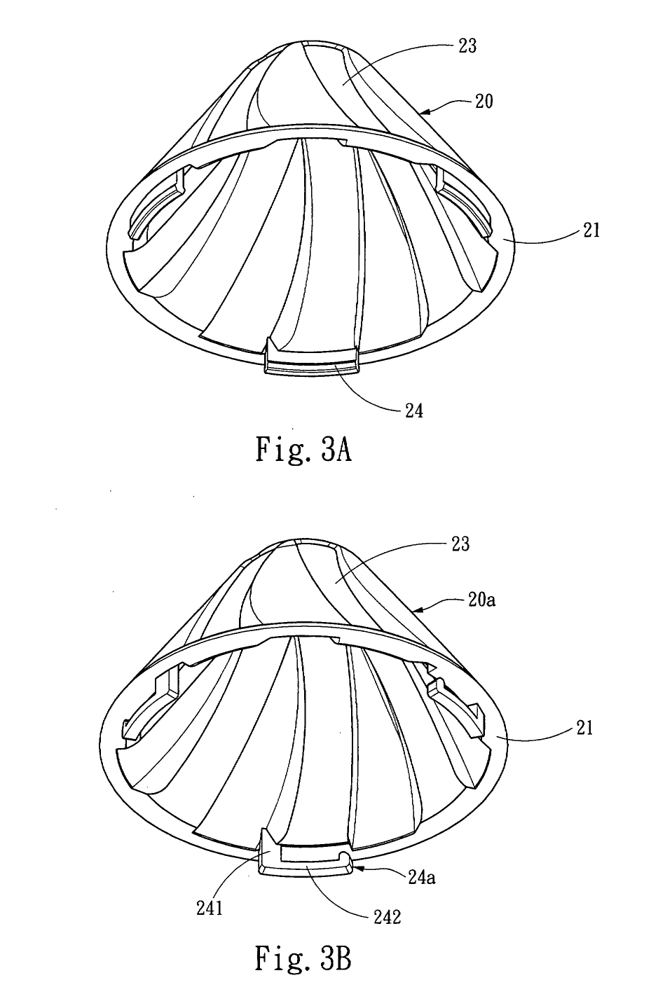

Refer to FIG. 3A and FIG. 3B, and also refer to FIG. 2. In one embodiment of the present invention, the airflow conduction body 20 and the electric fan 10 is fabricated into a one-piece part (not shown in the drawings). In another embodiment of the present invention, the first end face 21 of the airflow conduction body 20 has at least one first fixing member 24, and the electric fan 10 has at least one second fixing member 14; the airflow conduction body 20 and the electric fan 10 are integrated with the first and second fixing members 24 and 14, wherein the first and second fixing members 24 and 14 are respectively a hook tenon and a hook slot, and the hook tenon is press-fitted to the hook slot to securely fix the airflow conduction body 20 and the electric fan 10. As shown in FIG. 3B, in further another embodiment of the present invention, the first fixing member 24a of the airflow conduction body 20a has a radial segment 241 and a transverse segment 242; the second fixing member 14 is a slot corresponding to the first fixing member 24a and is like the second fixing member 14 shown in FIG. 2. The transverse segment 242 is placed into the slot, and the airflow conduction body 20a is rotated to make the radial segment 241 press against the inner wall of the slot, and the airflow conduction body 20 is thus securely fixed to the electric fan 10. In addition to the connection methods of the abovementioned embodiments, the airflow conduction body 20 may also be fixed to the electric fan 10 via sticking the first end face 21 with an adhesive (not shown in the drawings) to the central portion 13 of the electric fan 10. Alternatively, the airflow conduction body 20 may be joined with the electric fan 10 with a screwing method (not shown in the drawings). Although it is not described herein, the present invention also includes the embodiment using any another way to connect the airflow conduction body 20 with the electric fan 10.

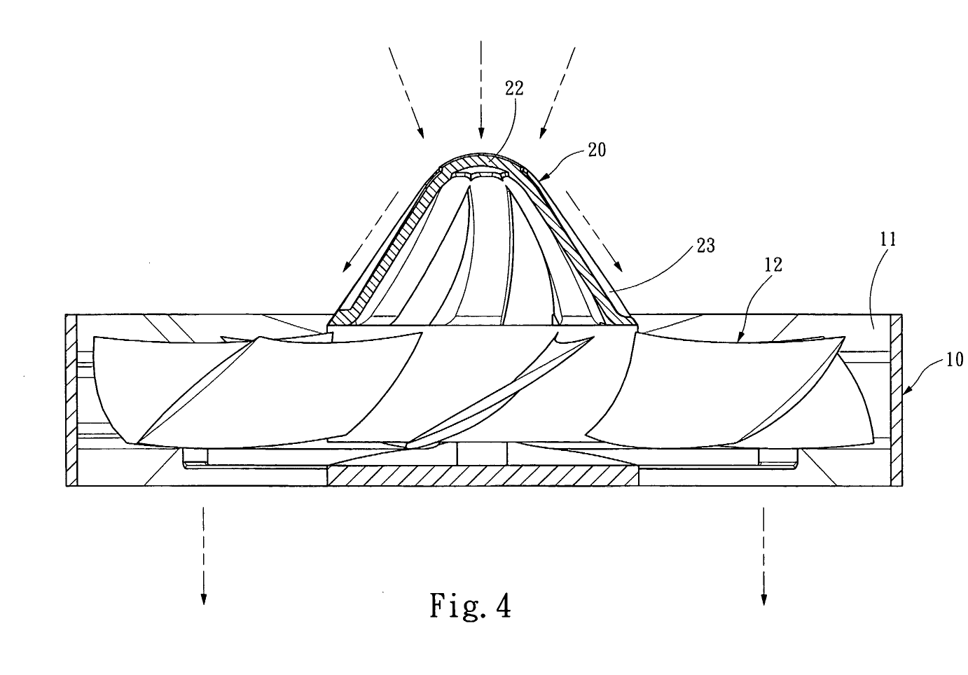

Refer to FIG. 4 a sectional view schematically showing the airflow flowing in the electric fan module and the airflow conduction structure according to the present invention. When the electric fan 10 operates to suck air, the air around the central portion 13 of the electric fan 10 will flow to the fan blades 12 along the airflow conduction grooves 23. Thereby, a vacuum state or wind resistance will not appear around the central portion 13, and the heat dissipation efficiency is promoted.

Those described above are only the preferred embodiments to exemplify the present invention but not to limit the scope of the present invention. Any equivalent modification or variation according to the spirit of the present invention is to be also included within the scope of the present invention.

What is claimed is:

1. An airflow conduction structure, which is connected with an electric fan, comprising:
an airflow conduction body having a first end face and a second end face with said first end face greater than said second end face; and
at least one airflow conduction groove axially formed on said airflow conduction body and arranged between said first end face and said second end face.

2. The airflow conduction structure according to claim 1, wherein said airflow conduction body is a truncated cone.

3. The airflow conduction structure according to claim 1, wherein said electric fan is an axial flow fan or a centrifugal fan.

4. The airflow conduction structure according to claim 3, wherein said electric fan has a casing and a fan blade assembly arranged inside said casing, and said fan blade assembly has a central portion corresponding to said first end face.

5. The airflow conduction structure according to claim 1, wherein said airflow conduction body and said electric fan are fabricated into a one-piece part.

6. The airflow conduction structure according to claim 1, wherein said first end face has at least one first fixing member, and said electric fan has at least one second fixing member corresponding to said first fixing member.

7. The airflow conduction structure according to claim 6, wherein said first fixing member is a hook tenon, and said second fixing member is a hook slot.

8. The airflow conduction structure according to claim 6, wherein said first fixing member has a radial segment and a transverse segment; said second fixing member is a slot corresponding to said first fixing member.

9. The airflow conduction structure according to claim 1, wherein said first end face has an adhesive, and said airflow conduction body is assembled to said electric fan via said adhesive.

10. The airflow conduction structure according to claim 1, wherein said airflow conduction grooves are radiately arranged on said airflow conduction body and corresponding to the airflow direction.

11. An electric fan module comprising:
an electric fan; and
at least one airflow conduction structure further comprising:
an airflow conduction body arranged in a position where air airflow of said electric fan passes, and having a first end face and a second end face with said first end face greater than said second end face; and
at least one airflow conduction groove axially formed on said airflow conduction body and arranged between said first end face and said second end face.

12. The electric fan module according to claim 11, wherein said airflow conduction body is a truncated cone.

13. The electric fan module according to claim 11, wherein said electric fan is an axial flow fan or a centrifugal fan.

14. The electric fan module according to claim 13, wherein said electric fan has a casing and a fan blade assembly arranged inside said casing, and said fan blade assembly has a central portion corresponding to said first end face.

15. The electric fan module according to claim 11, wherein said airflow conduction body and said electric fan are fabricated into a one-piece part.

16. The electric fan module according to claim 11, wherein said first end face has at least one first fixing member, and said electric fan has at least one second fixing member corresponding to said first fixing member.

17. The electric fan module according to claim 16, wherein said first fixing member is a hook tenon, and said second fixing member is a hook slot.

18. The electric fan module according to claim 16, wherein said first fixing member has a radial segment and a transverse segment; said second fixing member is a slot corresponding to said first fixing member.

19. The electric fan module according to claim 11, wherein said first end face has an adhesive, and said airflow conduction body is assembled to said electric fan via said adhesive.

20. The electric fan module according to claim 11, wherein said airflow conduction grooves are radiately arranged on said airflow conduction body and corresponding to the airflow direction.
